(19) United States
(12) Patent Application Publication
(10) Pub. No.: US 2012/0105896 A1
(43) Pub. Date: May 3, 2012

(54) IMAGE FORMING APPARATUS AND THRESHOLD SETTING METHOD

(75) Inventors: Mitsuo Ito, Hyogo (JP); Masato Kobayashi, Osaka (JP); Tomohiro Ohshima, Osaka (JP)

(73) Assignee: RICOH COMPANY, LIMITED, Tokyo (JP)

(21) Appl. No.: 13/278,297

(22) Filed: Oct. 21, 2011

(30) Foreign Application Priority Data
Oct. 29, 2010 (JP) 2010-244460

(51) Int. Cl. G06K 15/00

(52) U.S. Cl. 358/1.14

(57) ABSTRACT

An image forming apparatus includes: a detecting unit that detects illuminance; a storage unit that stores therein a threshold with respect to the illuminance in accordance with a distance from a light source to the image forming apparatus, the threshold being for switching to an energy-saving mode in which electricity is supplied only to a part of the image forming apparatus or for turning, off a power source; a comparison unit that compares a detected illuminance with the threshold; and a control unit that, if the detected illuminance is equal to or less than the threshold, causes the image forming apparatus to switch to the energy-saving mode or to turn off the power source.

### CROSS-REFERENCE TO RELATED APPLICATIONS

The present application claims priority to and incorporates by reference the entire contents of Japanese Patent Application No. 2010-244460 filed in Japan on Oct. 29, 2010.

### BACKGROUND OF THE INVENTION

1. Field of the Invention

The present invention relates to an image forming apparatus and a threshold setting method.

2. Description of the Related Art

With the aim of reducing power consumption when a user forgets to cut the power supply, a conventional technology is known to enable an image forming apparatus to switch to a power-saving mode or to cut a power supply by detecting brightness, i.e., illuminance, around the image forming apparatus, and by determining if the detected illuminance is darker than a predetermined reference illuminance (for example, Patent Japanese Patent Application Laid-open No. 2006-184346).

In this conventional technology, a method to set the reference illuminance (threshold) is not considered; therefore, it is difficult to appropriately set the reference illuminance.

Specifically, each user of an image forming apparatus usually has a different sense of brightness and, even if reference brightness is converted to a numerical value to be determined as an illuminance threshold, because a user does not share a common knowledge or sense of illuminance with another user, it is difficult to appropriately set a reference illuminance. Accordingly, even if switching to the energy-saving mode or cutting the power supply is performed using the illuminance threshold as a reference, it is difficult to switch to the energy-saving mode or to cut the power supply at a brightness (darkness) satisfactory to every user. As a result, it is difficult to properly reduce the power consumption.

### SUMMARY OF THE INVENTION

It is an object of the present invention to at least partially solve the problems in the conventional technology.

According to an aspect of the present invention, there is provided an image forming apparatus including: a detecting unit that detects illuminance; a storage unit that stores therein a threshold with respect to the illuminance in accordance with a distance from a light source to the image forming apparatus, the threshold being for switching to an energy-saving mode in which electricity is supplied only to a part of the image forming apparatus or for turning off a power source; a comparison unit that compares a detected illuminance with the threshold; and a control unit that, if the detected illuminance is equal to or less than the threshold, causes the image forming apparatus to switch to the energy-saving mode or to turn off the power source.

According to another aspect of the present invention, there is provided a threshold setting method performed by an image forming apparatus. The method includes measuring a distance from a light source to the image forming apparatus; detecting illuminance at a position where the image forming apparatus is installed; and setting a threshold with respect to the illuminance in a storage unit in accordance with the measured distance, the threshold being for switching to an energy-saving mode or for turning off a power source.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is an external view of a multifunction peripheral 1 according to the present embodiment;

FIG. 2 is an external view of an operation panel 2;

FIG. 3 is a hardware configuration diagram of a control section according to the present embodiment;

FIG. 4 is a configuration diagram of an illuminance sensor board 312;

FIG. 5 is a block diagram illustrating the functional configuration of a power-source control in the multifunction peripheral 1 of the present embodiment;

FIG. 6 is a table describing the relation between luminance and a threshold;

FIG. 7 is a schematic view illustrating the relation between a threshold and distance;

FIG. 8 is a flowchart illustrating a procedure of a power-source control process of the present embodiment; and

FIG. 9 is a flowchart illustrating a procedure of a method for setting a threshold.

### DETAILED DESCRIPTION OF THE PREFERRED EMBODIMENTS

Exemplary embodiments of an image forming apparatus and a method for setting a threshold according to the present invention are explained in detail below with reference to the accompanying drawings. An explanation is given below of the embodiments by using an image forming apparatus, as an example, that is used in a multifunction peripheral having at least two functions among a copying function, printer function, scanner function, and facsimile function; however, the embodiments can be applied to any image forming apparatus, such as a copying machine, printer, scanner apparatus, or facsimile apparatus.

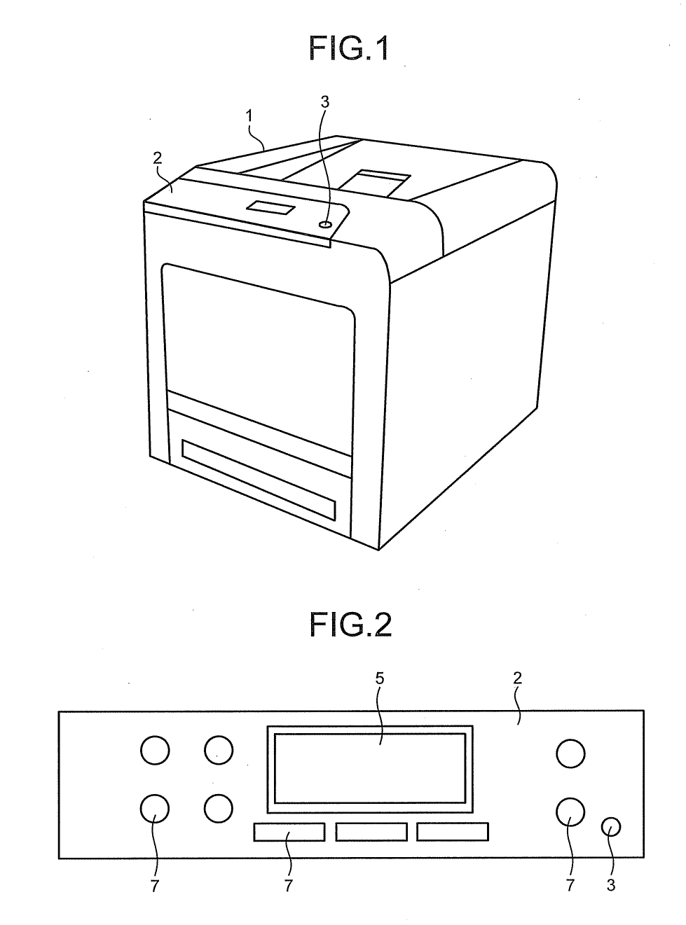

FIG. 1 is an external view of a multifunction peripheral 1 according to the present embodiment. As illustrated in FIG. 1, an operation panel 2 is arranged on a top surface of a casing of the multifunction peripheral 1. FIG. 2 is an external view of the operation panel 2.

The operation panel 2 includes a liquid-crystal display unit 5, various buttons 7, and a light receiving window 3. The liquid-crystal display unit 5 displays various screens to a user of the multifunction peripheral 1. Different types of instructions are received when various buttons are pressed by a user. The light receiving window 3 receives light emitted from a light source.

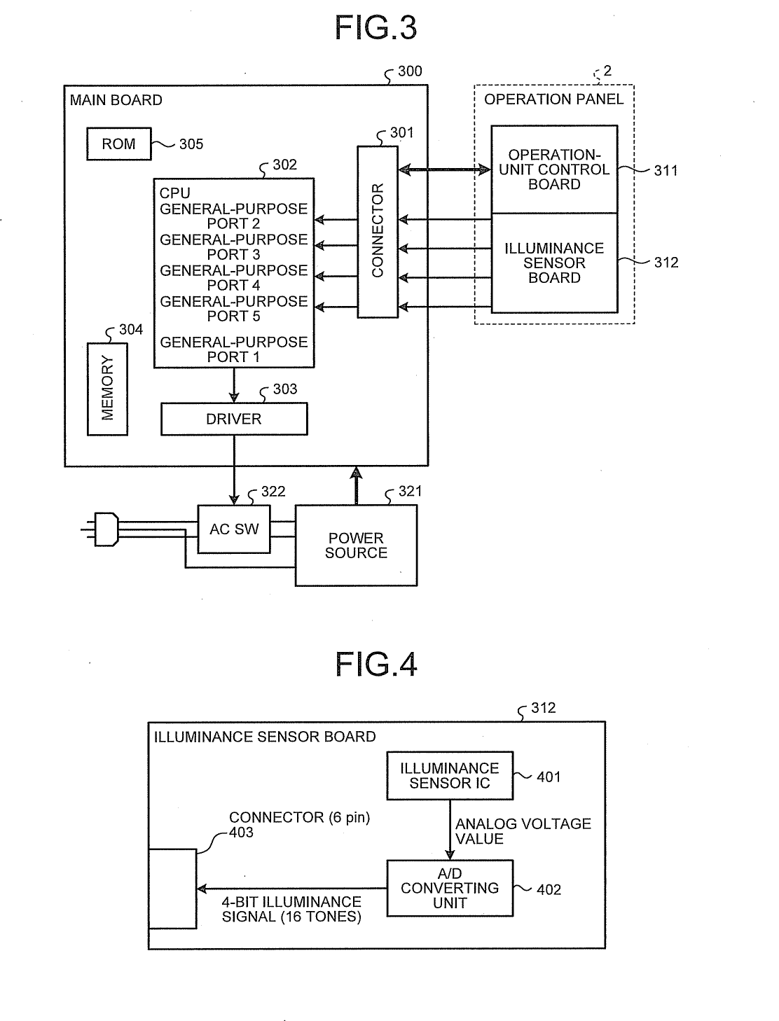

FIG. 3 is a hardware configuration diagram of a control section according to the present embodiment. As illustrated in FIG. 3, the multifunction peripheral of the present embodiment has a configuration in which the operation panel 2 is connected to a main board 300.

An operation-unit control board 311 and an illuminance sensor board 312 are arranged inside the operation panel 2. The operation-unit control board 311 has a module for controlling input/output from/to the liquid-crystal display unit 5 and has a module for controlling input from the various buttons 7.

The illuminance sensor board 312 has an illuminance sensor (not illustrated). The illuminance sensor receives light that is taken through the light receiving window 3, converts an intensity of the light into an electric signal, and sends the electric signal to the main board 300. FIG. 4 is a configuration diagram of the illuminance sensor board 312. The illuminance sensor board 312 includes an illuminance sensor integrated circuit (IC) 401 that includes the illuminance sensor, an analog/digital (A/D) converter 402 that is a conversion unit, and a connector 403.

The illuminance sensor IC 401 detects as illuminance the intensity of light received by the illuminance sensor and outputs to the A/D converter 402 an analog voltage value according to the illuminance.

The A/D converter 402 receives from the illuminance sensor IC 401 an analog voltage value depending on the illuminance and converts the analog voltage value to an A/D value that is a digital signal. The A/D converter 402 further converts the A/D value to a 4-bit illuminance signal (a first digital value) that has 16 tones and outputs the signal to the main board 300 via the connector 403. The connector 403 has a 6-pin terminal and is connected to the main board 300.

Because an illuminance sensor usually used outputs analog values, the main board needs to perform analog signal processing to process an analog voltage value that is an illuminance output; therefore, it has been difficult to manufacture a general-purpose main board.

In the present embodiment, in the illuminance sensor board 312, an analog voltage value output from the illuminance sensor is converted into a 4-bit illuminance signal that is a multiple-value digital signal, and then is output to the main board 300. Thus, the main board 300 of the present embodiment does not need to perform analog signal processing and, because it is only necessary to arrange general-purpose input terminals, such as general-purpose ports 1 to 5, the configuration of the main board 300 can have general versatility. Because the illuminance sensor board 312 does not use an analog value as a threshold, an analog/digital converting unit, or the like, can be omitted.

As illustrated in FIG. 3, the main board 300 is connected to a power source 321 so as to receive an electricity supply from the power source 321. The main board 300 is connected to an AC power switch (hereafter, referred to as “AC SW”) 322. The AC SW 322 is a switch that turns on and off the power source 321.

As illustrated in FIG. 3, the main board 300 mainly includes a connector 301, a central processing unit (CPU) 302, a memory 304 that is a storage unit, a driver 303, and a read only memory (ROM) 305. The connector 301 connects the main board 300 to the operation-unit control board 311 and the illuminance sensor board 312. The connector 301 is connected to the connector 403 of the illuminance sensor board 312.

The CPU 302 includes the general-purpose ports 1 to 5. The CPU 302 receives a 4-bit illuminance signal from the illuminance sensor board 312 via the general-purpose ports 2 to 5 and the connector 301.

The memory 304 stores a threshold with respect to illuminance. The details of the threshold will be described later. The CPU 302 compares a received 4-bit illuminance signal with the threshold with respect to illuminance and, by using the result of the comparison, outputs from the general-purpose port 1 a command to turn off the power source or to switch to an energy-saving mode in which the electric power is supplied to only a part of the image forming apparatus. In the present embodiment, the energy-saving mode includes a stand-by mode, sleep mode, or the like.

The CPU 302 receives input signals from the operation-unit control board 311 and controls the overall multifunction peripheral 1. Furthermore, the CPU 302 sends to the operation-unit control board 311 signals or various types of image data to be displayed on the liquid-crystal display unit 5 of the operation panel 2.

The driver 303 drives the AC SW 322 in response to a command from the CPU 302. The ROM 305 stores a computer program for controlling the multifunction peripheral 1, such as a power-source control program that is executed by the CPU 302, and the like.

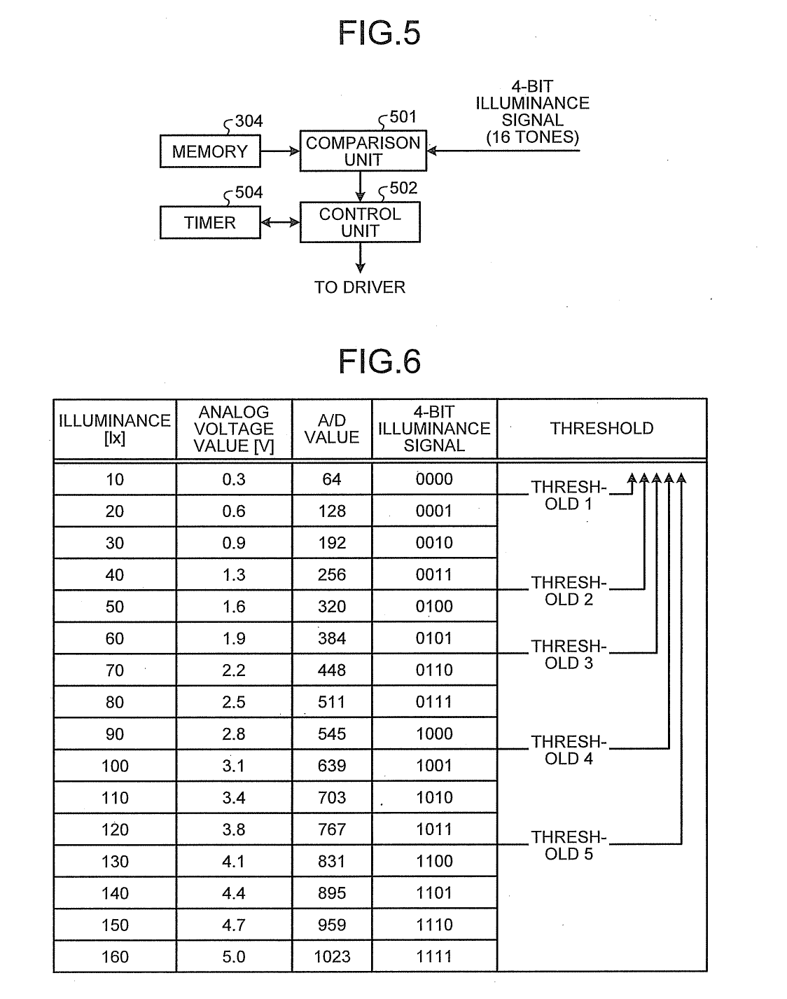

An explanation is given of a function executed by the CPU 302 using the power-source control program. FIG. 5 is a block diagram that illustrates the functional configuration of the multifunction peripheral 1 of the present embodiment in regard to the power-source control. As illustrated in FIG. 5, the section of the multifunction peripheral 1 of the present embodiment related to the power-source control mainly includes a comparison unit 501, a control unit 502, a timer 504, and the above-described memory 304.

The comparison unit 501 compares a 4-bit illuminance signal with a threshold (a second digital value) stored in the memory 304. The control unit 502 outputs to the driver 303 a command to switch to the energy-saving mode or a command to turn off the power source if a 4-bit illuminance signal is equal to or less than the threshold. Thus, the control unit 502 controls the switching to the energy-saving mode and the turning-off of the power source. The timer 504 measures a predetermined time.

The power-source control program to be executed by the multifunction peripheral 1 of the present embodiment is provided by being pre-installed in the ROM 305, or the like.

A configuration may be such that the power-source control program to be executed by the multifunction peripheral 1 of the present embodiment is provided by being stored, in the form of a file that is installable or executable, in a recording medium readable by a computer, such as a CD-ROM, a flexible disk (FD), a CD-R, or a digital versatile disk (DVD).

Furthermore, a configuration may be such that the power-source control program to be executed by the multifunction peripheral 1 of the present embodiment is stored in a computer connected to a network such as the Internet and provided by being downloaded via the network. Moreover, a configuration may be such that the power-source control program to be executed by the multifunction peripheral 1 of the present embodiment is provided or distributed via a network such as the Internet.

The power-source control program to be executed by the multifunction peripheral 1 of the present embodiment has a modular configuration that includes the above-described units (the comparison unit, the control unit, and the timer). In terms of actual hardware, the CPU 302 reads the power-source control program from the above-described ROM 305 and executes the read program so as to load the above-described units into a main storage device so that the comparison unit, the control unit, and the timer are generated in the main storage device.

An explanation is given of the threshold stored in the memory 304. In the present embodiment, the actual illuminance is not used as a threshold. The threshold has a value corresponding to a value with respect to illuminance, i.e., a value of the above-described 4-bit illuminance signal.

FIG. 6 is a table that describes the relation between illuminance and a threshold. As described above and as illustrated in FIG. 6, the illuminance detected by the illuminance sensor is output from the illuminance sensor IC 401 as an analog voltage value corresponding to the illuminance, the analog voltage value is converted by the A/D converter 402 into an A/D value and then into a 4-bit illuminance signal, and then the signal is sent to the main board 300. In the present embodiment, a threshold is set not with respect to the actual illuminance but with respect to a 4-bit illuminance signal (the first digital value) that has 16 levels.

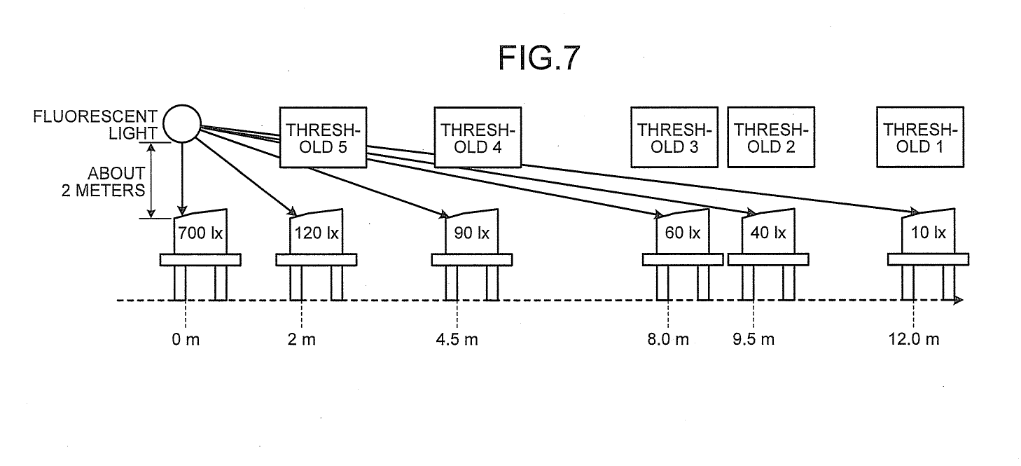

According to the present embodiment, the threshold with regard to the illuminance is determined in accordance with a distance from the light source to the multifunction peripheral 1. FIG. 7 is a schematic view that illustrates the relation between a threshold and a distance. Specifically, as illustrated in FIG. 7, the illuminance threshold is set to a lower value as the distance between the light source (the fluorescent light in FIG. 7) and the, multifunction peripheral 1 increases.

In other words, according to the present embodiment, in order to determine a threshold for switching to the energy-saving mode or for turning off the power source, the illuminance is considered in terms of the horizontal distance from the light source to the multifunction peripheral 1. The reason for this is that each user of the multifunction peripheral 1 has a different sense of brightness and, even if the brightness is measured as illuminance in numerical terms, a user does not share a common knowledge or sense of illuminance with another user; therefore, if the threshold is considered in terms of the actual illuminance in switching to the energy-saving mode or in turning off the power source of the multifunction peripheral 1, it is difficult to switch to the energy-saving mode or to turn off the power source at a brightness (darkness) satisfactory to every user. On the other hand, in the present embodiment, a threshold is determined on the basis of the distance from the light source to the multifunction peripheral 1; thus, the brightness is determined on the basis of the distance that a user can instinctively determine, and it is possible to switch to the energy-saving mode or to turn off the power source at a brightness (darkness) satisfactory to many users.

For instance, in the examples illustrated in FIGS. 6 and 7, the threshold 1 is pre-set by using as a measure the brightness of moonlight, the threshold 3 by using as a measure the brightness inside a movie theater while a movie is playing, and the threshold 5 by using as a measure the brightness of a room in the evening after the sun has set.

As illustrated in FIG. 7, in the case of the multifunction peripheral 1 for which the threshold 3 has been set, if it is appropriate to automatically turn off the power source when the multifunction peripheral 1 is located away from the light source by a horizontal distance equal to or more than 8 meters, the 4-bit illuminance signal corresponding to the illuminance measured at the position 8 meters away from the light source is set to the threshold 3.

Although it is difficult to set each threshold by directly using illuminance, there is an advantage for the present embodiment in that it is easy to determine a threshold by using a horizontal distance from the light source.

In the present embodiment, the threshold has a lower value as the distance from the light source to the position where the multifunction peripheral 1 is located increases, and the threshold is determined as a value corresponding to a 4-bit illuminance signal and set in the memory 304.

According to the present embodiment, as illustrated in FIG. 6, the memory 304 stores a table describing the relation of the thresholds such that each has a lower value as the horizontal distance from the light source to the multifunction peripheral 1 increases. The threshold to be used in the multifunction peripheral 1 is specified in this table by marking, or the like. The present invention is not limited thereto, and a configuration may be such that only the threshold to be used in the multifunction peripheral 1 is stored in the memory 304.

In the example illustrated in the table in FIG. 6, because an illuminance signal has 4 bits, a threshold can be set by choosing a level from the 16 levels of the 4-bit illuminance signals; however, the number of levels can be arbitrarily determined in accordance with the number of bits of an illuminance signal input from the illuminance sensor board 312.

Furthermore, in the example illustrated in the table in FIG. 6, an arbitrary threshold is set by choosing a level from the 16 levels of the 4-bit illuminance signal such that the threshold has a lower value as the horizontal distance increases; however, the present invention is not limited thereto. A threshold can be set by choosing a level from the 16 levels of the 4-bit illuminance signal at an equal interval if a setting is made such that the threshold has a lower value as the horizontal distance increases. Furthermore, a configuration may be such that a threshold is set according to a linear function or nonlinear function with respect to the 4-bit illuminance signal.

The threshold can be changed if it is determined that the threshold is inappropriate while the multifunction peripheral 1 is operating.

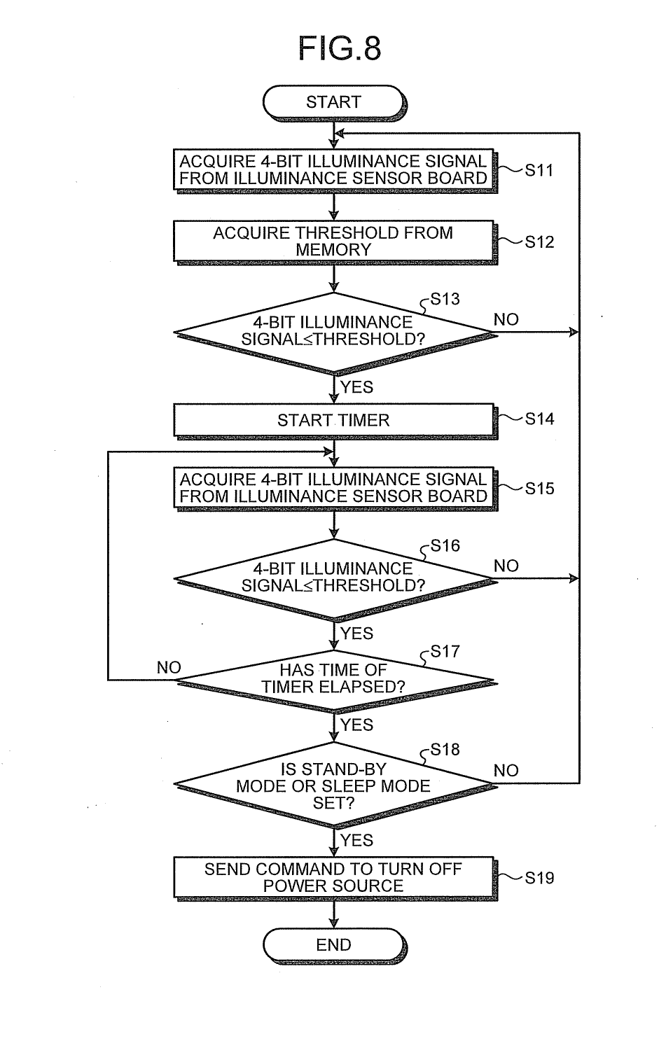

An explanation is given of a power-source control process performed by the multifunction peripheral 1 that is configured as described above according to the present embodiment. FIG. 8 is a flowchart that illustrates a procedure of the power-source control process of the present embodiment. In FIG. 8, an explanation is given of, for example, a case where the power source is turned off; however, switching to the energy-saving mode may be performed similarly.

First, the comparison unit 501 acquires a 4-bit illuminance signal from the illuminance sensor board 312 (Step S11). The comparison unit 501 acquires from the memory 304 the threshold that is set according to the distance from the light source to the multifunction peripheral 1 (Step S12).

Then, the comparison unit 501 compares the 4-bit illuminance signal with the threshold and determines whether the 4-bit illuminance signal is equal to or less than the threshold (Step S13). If the 4-bit illuminance signal is more than the threshold (No at Step S13), the process returns to Step S11.

Conversely, if the 4-bit illuminance signal is equal to or less than the threshold (Yes at Step S13), the control unit 502 starts the timer 504 (Step S14).

The comparison unit 501 acquires from the illuminance sensor board 312 a 4-bit illuminance signal again (Step S15), compares the 4-bit illuminance signal with the threshold, and determines whether the 4-bit illuminance signal is equal to or less than the threshold (Step S16). If the 4-bit illuminance signal is more than the threshold (No at Step S16), the process returns to Step S11. Conversely, if the 4-bit illuminance signal is equal to or less than the threshold (Yes at Step S16), the control unit 502 determines whether the time set by the timer 504 has elapsed (Step S17). If the time has not elapsed (No at Step S17), the process returns to Step S15.

If the time has elapsed (Yes at Step S17), the control unit 502 refers to the current mode that is set in the memory 304 so as to determine whether the multifunction peripheral 1 is currently in an energy-saving mode, such as a stand-by mode or sleep mode (Step S18). If the multifunction peripheral 1 is not in the energy-saving mode (No at Step S18), the process returns to Step S11.

If the multifunction peripheral 1 is in an energy-saving mode (Yes at Step S18), the control unit 502 sends to the driver 303 a command to turn off the power source (Step S19). Thus, the driver 303 switches off the AC SW 322 and the power source 321 is turned off.

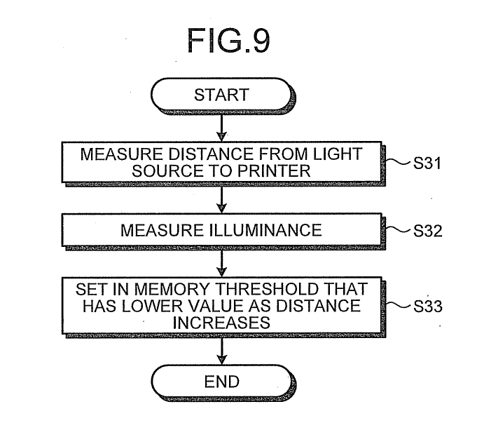

An explanation is given of a method for setting a threshold. FIG. 9 is a flowchart that illustrates a procedure of a method for setting a threshold. The threshold setting process is performed when the multifunction peripheral 1 is installed. However, if it is determined that the threshold is not appropriate when the installed multifunction peripheral 1 is operating, the threshold setting process may be performed again to change the threshold.

First, the distance from the light source to the multifunction peripheral 1 is measured (Step S31). Next, the illuminance sensor measures the illuminance (Step S32). As described above, the measured illuminance is converted into a 4-bit illuminance signal that is a digital value, and the signal is input to the main board 300.

The 4-bit illuminance signals, each of which has a lower value as the distance increases, are pre-set in levels corresponding to the distances and are stored in the memory 304, or the like, as illustrated in the table in FIG. 6. By referring to this table, the 4-bit illuminance signal corresponding to the measured distance is determined as a threshold and set in the memory 304 (Step S33).

The above-described method for setting a threshold may be performed by a system manager or may be executed by the CPU 302 of the multifunction peripheral 1. In such a case, the multifunction peripheral 1 may be configured such that a distance sensor is pre-installed in the multifunction peripheral 1, and the measurement of the distance at Step S31 may be performed by the distance sensor that measures the distance from the light source to the multifunction peripheral 1.

In such a case, like the example illustrated in the table in FIG. 6, an arbitrary threshold is set by choosing a level from the 16 levels of the 4-bit illuminance signal such that the threshold has a lower value as the horizontal distance increases. Furthermore, a threshold can be set from the 16 levels of, the 4-bit illuminance signal at an equal interval if a setting is made such that the threshold has a lower value as the horizontal distance increases. Furthermore, a configuration may be such that a threshold is set according to a linear function or nonlinear function with respect to the 4-bit illuminance signal.

According to the present embodiment, a threshold for switching to the energy-saving mode or for turning off the power source is not determined with respect to a value of the actual illuminance but with respect to the distance from the light source to the multifunction peripheral 1 such that the threshold has a lower value as the distance increases. In the present embodiment, it is possible to correctly set an illuminance criterion and, because the brightness is determined on the basis of the distance that a user can instinctively determine, it is possible to switch to the energy-saving mode or to turn off the power source at a brightness (darkness) satisfactory to many users; thus, it is possible to appropriately reduce the power consumption.

In the present embodiment, the illuminance sensor board 312 converts an analog voltage value output from the illuminance sensor into a 4-bit illuminance signal that is a multiple-value digital signal and outputs the signal to the main board 300. Thus, the main board 300 does not require analog signal processing so that the configuration of the main board 300 has general versatility.

Modified Example

In the present embodiment, the threshold is set according to the horizontal distance from the single light source to the multifunction peripheral 1; however, the threshold may be set according to the horizontal distance from each of a plurality of light sources to the multifunction peripheral 1.

Furthermore, in the present embodiment, the threshold is set according to only the horizontal distance from the light source to the multifunction peripheral 1; however, the threshold may be set according to additional factors, such as a function of the multifunction peripheral 1.

Specifically, in addition to the distance from the light source to the multifunction peripheral 1, the threshold may be set according to a function of the multifunction peripheral 1. For example, if the multifunction peripheral 1 has higher functionality, the threshold with a lower value may be set in the memory 304.

In the example of FIG. 7, as the horizontal distance from the light source increases, a threshold with a lower value is set, such as threshold 5, then threshold 4, down to threshold 1. For example, if the multifunction peripheral 1 is located away from the light source by the horizontal distance of 4.5 meters and has higher functionality capable of color printing, duplex printing, and a number of types of sheet post-processing and if other multifunction peripherals do not have such functionality, the multifunction peripheral 1 located away by the horizontal distance of 4.5 meters is turned on even if the installation area becomes dark, which results in a user's convenience.

In such a case, in addition to setting a threshold according to the horizontal distance, the threshold of the multifunction peripheral 1 that has higher functionality is set lower than that of the multifunction peripheral that is arranged at a horizontal distance farther away. In the above-described example, the threshold 1, or the like, that is the lowest value is set to the multifunction peripheral 1 that is located away by the horizontal distance of 4.5 meters. Thus, the power source of the multifunction peripheral 1 that has higher functionality is not turned off or switched to the energy-saving mode even if the surrounding brightness is decreased, which results in a user's convenience.

In this case, the threshold may be set according to a function of the multifunction peripheral 1 at Step S33 of the threshold setting method described with reference to FIG. 9, i.e., a threshold with a lower value is determined because the multifunction peripheral 1 has higher functionality and the determined threshold is set in the memory 304.

According to an aspect of the present invention, it is possible to correctly set an illuminance threshold that is a criterion for switching to a power-saving mode or turning off the power source. Furthermore, according to another aspect of the present invention, because it is possible to correctly set an illuminance threshold, the power consumption can be reduced more appropriately.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. An image forming apparatus comprising:
a detecting unit that detects illuminance;
a storage unit that stores therein a threshold with respect to the illuminance in accordance with a distance from a light source to the image forming apparatus, the threshold being for switching to an energy-saving mode in which electricity is supplied only to a part of the image forming apparatus or for turning off a power source;
a comparison unit that compares a detected illuminance with the threshold; and
a control unit that, if the detected illuminance is equal to or less than the threshold, causes the image forming apparatus to switch to the energy-saving mode or to turn off the power source.

2. The image forming apparatus according to claim 1, further comprising a converting unit that converts the detected illuminance into a first digital value, wherein
the storage unit stores, as the threshold, a second digital value that corresponds to the illuminance in accordance with the distance,
the comparison unit compares the first digital value with the second digital value, and
if the first digital value is equal to or less than the second digital value, the control unit causes the image forming apparatus to switch to the energy-saving mode or to turn off the power source.

3. The image forming apparatus according to claim 2, further comprising:
a first board; and
a second board that is connected to the first board, wherein
the first board includes the detecting unit and the converting unit, and
the second board includes the comparison unit and the control unit.

4. The image forming apparatus according to claim 1, wherein the storage unit stores the threshold that has a lower value as the distance increases.

5. The image forming apparatus according to claim 4, wherein the storage unit stores the threshold according to functionality of the image forming apparatus.

6. The image forming apparatus according to claim 5, wherein the storage unit stores the threshold that has a lower value if the image forming apparatus has higher functionality.

7. A threshold setting method performed by an image forming apparatus, the method comprising:
measuring a distance from a light source to the image forming apparatus;
detecting illuminance at a position where the image forming apparatus is installed; and
setting a threshold with respect to the illuminance in a storage unit in accordance with the measured distance, the threshold being for switching to an energy-saving mode or for turning off a power source.

8. The threshold setting method according to claim 7, wherein the setting includes setting in the storage unit the threshold that has a lower value as the distance increases.

9. The threshold setting method according to claim 8, wherein the setting includes setting in the storage unit the threshold according to functionality of the image forming apparatus.

10. The threshold setting method according to claim 8, wherein the setting includes setting in the storage unit the threshold that has a lower value if the image forming apparatus has higher functionality.
